(19) United States
(12) Patent Application Publication
(10) Pub. No.: US 2024/0170973 A1
(43) Pub. Date: May 23, 2024

(54) BATTERY MANAGEMENT SYSTEM FOR MULTIPLE BATTERY CIRCUITS HAVING DIFFERENT VOLTAGES

(71) Applicant: DELTRAN OPERATIONS USA, INC., DELAND, FL (US)

(72) Inventors: Peter James Shread, Celebration, FL (US); Edward William Brumley, Port Orange, FL (US)

(73) Assignee: DELTRAN OPERATIONS USA, INC., DELAND, FL (US)

(21) Appl. No.: 17/992,767

(22) Filed: Nov. 22, 2022

(51) Int. Cl. H02J 7/00; H01M 10/42; H01M 10/44

(52) U.S. Cl. CPC H02J 7/0013; H01M 10/425; H01M 10/441; H02J 7/00714; H01M 2010/4271; H01M 2220/20

(57) ABSTRACT

A battery management system for two or more battery circuits on a vessel in which the battery circuits may be charged by a motor on the vessel or by a power source positioned remotely from the vessel is disclosed. As such, the two battery circuits may have different nominal voltages configured to provide different voltages to different devices onboard the vessel. The battery management system may receive input power from the motor on the vessel to charge the battery circuits on the vessel. The battery management system may be configured such that when the battery management system is not receiving power from a motor on the vessel, the battery management system may receive power from a power source positioned remotely from the vessel, such as, a municipal power supply. The battery management system may also include a communication system enabling battery management data to be shared with users.

### BACKGROUND

The invention relates to battery management systems, and more particularly, to battery management systems configured with multiple battery circuits with engine start batteries or deep cycle batteries, or both, having different voltages.

Boats often have multiple battery circuits such as a starting battery circuit, a house battery circuit and on some vessels, a trolling motor circuit. The starting battery circuit is charger by an alternator on the motor of the boat. When the motor is running, the alternator is generating electrical potential voltage greater than the nominal voltage of the starting battery circuit, which often is 12 volts. The high voltage current functions as a charging current to the starting battery circuit. In some configurations, the house battery circuit and the trolling motor circuit are also 12 volts and are configured to receive charging power from the alternator on the motor of the boat. In other embodiments, the trolling motor circuit and other circuits are at a different voltage, such as 24 volts, 36 volts and 48 volts, relative to the starting battery circuit. Although the starting motor battery circuit is charged while the motor of the boat is running, the trolling motor battery circuit and other higher voltage circuits are not. As a result, the trolling motor battery circuit only has the energy that is stored within the batteries in the trolling motor battery circuit. Once the trolling motor battery circuit is dead, the trolling motor in inoperable until the boat returns to the dock where the trolling motor battery circuit can be charged. Thus, a need exists for charging batteries with multiple battery circuits having different voltages.

### SUMMARY OF THE INVENTION

A battery management system for two or more battery circuits on a vessel in which the battery circuits may be charged by a motor on the vessel or by a power source positioned remotely from the vessel is disclosed. As such, the two battery circuits may have different nominal voltages configured to provide different voltages to different devices onboard the vessel. The battery management system may receive input power from the motor on the vessel to charge the at least two battery circuits on the vessel. The battery management system may be configured such that when the battery management system is not receiving power from a motor on the vessel, the battery management system may receive power from a power source positioned remotely from the vessel, such as, a municipal power supply. The battery management system may also include a communication system enabling battery management data to be shared with users.

In at least one embodiment, the battery management system may include a controller configured to be coupled to multiple battery circuits and may include a first outlet configured to be coupled to at least one first battery circuit having a first nominal voltage and a second outlet configured to be coupled to at least one second battery circuit having a second nominal voltage that differs from the first nominal voltage of the at one first battery circuit. The battery management system may include one or more first power inputs configured to be coupled to an electrical output from one or more motors of the vessel. The battery management system may include one or more second power inputs configured to be coupled to a power source other than the motor of the vessel. The controller may be configured to generate a first charging current according to a first charging profile for charging batteries in the least one first battery circuit having the first nominal voltage and a second charging current according to a second charging profile for charging batteries in the least one second battery circuit having the second nominal voltage. The controller may be configured to generate the first and second charging currents simultaneously. In at least one embodiment, battery management system may include a third outlet configured to be coupled to one or more third battery circuits having a third nominal voltage that differs from at least the first nominal voltage of the first battery circuit.

The battery management system may include a first bus configured to be coupled to the first outlet to receive the first charging current according to the first charging profile for charging at least one battery in the at least one first battery circuit. The first nominal voltage of the first battery circuit may be 12 volts. The first bus may be in communication with 12 volt accessories, such as, but are not limited to, smartphones, spotlights, rechargeable portable speakers and the like.

The battery management system may include a second bus configured to be coupled to the first outlet to receive the second charging current according to the second charging profile for charging one or more batteries in the at least one second battery circuit. The second nominal voltage of the second battery circuit is greater than 12 volts. In at least one embodiment, the second nominal voltage of the at least one second battery circuit may be 24 volts, 36 volts, 48 volts or other voltages other than 12 volts.

In at least one embodiment, the battery management system may be configured such that the system can determine whether power is being supplied from a motor of a vessel or from another source, such as, but not limited to, power off of a vessel, such as municipal power, otherwise referred to as shore power. In at least one embodiment, the first outlet and the first power input may be coupled together such that when the controller is receiving power from the electrical output from the motor of the vessel, a common bus coupled to the first output and the first power input functions as power input to the controller. When the controller is receiving power from a source other than the motor of the vessel, such as shore power, the common bus coupled to the first output and the first power input functions as power output from the controller. The controller may be configured to provide notification of whether input power is received by the controller from the motor of the vessel or another source.

The battery management system may include a communications system for transmitting data from the controller to one or more remote devices viewable by a user. The remote device may be, but is not limited to being, a vessel information system on the vessel, a mobile device, such as, but not limited to, a smartphone, or other device capable of wired or wireless communications. The communications system may transmit data wirelessly from the controller to the remote device, such as via a smartphone app, wireless or wired communications to vessel information system on the vessel and wirelessly to a cellular or satellite communications system or other.

The battery management system may include a notification system configured to provide notification of data regarding the first battery circuit having the first nominal voltage and data regarding the second battery circuit having the second nominal voltage. The notification system is configured to provide notification of an out of specification condition of the first battery circuit having the first nominal voltage.

The battery management system may include a first alternating current input module configured to be removably positioned inline between the controller and a power source other than the motor of the vessel and a second alternating current input module configured to be removably positioned inline between the controller and a power source other than the motor of the vessel. The second alternating current input module may have a different maximum amperage than the first alternating current input module.

The battery management system may include a machine learning model configured to generate predictions relative to the first battery circuit having the first nominal voltage. The machine learning model may be configured to generate predictions relative to the second battery circuit having a second nominal voltage. The machine learning model may be configured to receive data from the controller, process the data and generate one or more predictions relative to the first battery circuit having the first nominal voltage

An advantage of this system is that two or more battery circuits having different voltages onboard a vessel may be charged simultaneously either when the motor of the vessel is running or when the system is receiving power from another source, such as municipally supplied power, shore power, generator power and the like.

Another advantage of this system is that a high voltage system, such as, but not limited to, a trolling motor system, may be charged simultaneously to a starting battery circuit, which is typically at a lower voltage, such as, but limited to, 12 volts.

Yet another advantage of this system is that both the high voltage system, such as, but not limited to, a trolling motor system, may be charged when the motor is running. Thus, when a boat is being moved from one fishing spot to another, the motor charges the high voltage, trolling motor system and the other battery circuits, such as, but not limited to, a starting battery circuit and a house battery circuit.

Another advantage of this system is that the battery management system is configured to regulate both voltage and current into a cell pack, thereby eliminating charging system instability which can damage cells.

Still another advantage of this system is that the system is that a user, such as, but not limited to, a captain or owner of the vessel, can receive real-time data, including alerts and alarms, from the battery management system, thereby enabling the user to be up to date on the state of the batteries and battery circuits on the vessel.

Another advantage of this system is that the battery management system is configured to communicate real-time data, including alerts and alarms, from the battery management system to an account on a database enabling a user, such as, but not limited to, a captain or owner of the vessel, to access, view, use and respond to the real-time data.

Yet another advantage of this system is that the battery management system is configured to generate alerts and alarms for undercharged batteries below a threshold voltage.

Another advantage of this system is that the battery management system is configured to predict when one or more batteries will reach certain levels of discharge, such as 75 percent, 50 percent and 25 percent, based on the current rate of use of the batteries.

Still another advantage of this system is that the system can provide notification of whether the battery management system is receiving power and from which source the battery management system is receiving the power, such as from the motor of the vessel, shore power or another source.

Another advantage of this system is that the battery management system is configured to provide notification to connect the battery management system to shore power to charge batteries before use of the vessel if the system is not already receiving power.

These and other embodiments are described in more detail below.

### BRIEF DESCRIPTION OF THE FIGURES

FIG. 1 is a perspective view of a vessel with a battery management system installed therein.

FIG. 2 is a detail view of the inside the console of the vessel where the batter management system is housed, taken at detail 2-2 in FIG. 1.

FIG. 3 is a schematic diagram of a portion of the battery management system.

FIG. 4 is a schematic diagram of the battery management system with first and second battery circuits and other elements.

FIG. 5 is a schematic diagram of the battery management system.

FIG. 6 is a schematic diagram of the battery management system and associated power supplies and user interface.

FIG. 7 is a schematic diagram of battery management systems in communication with a remote database and accessible via one or more users.

FIG. 8 is a communication system enabling the battery management system to communicate data to a remote data base and enabling users to remotely access the battery management system's data, alerts and notifications.

FIG. 9 is a schematic diagram of a computer processor configured to perform the operations of the systems of FIG. 8.

### DETAILED DESCRIPTION OF THE FIGURES

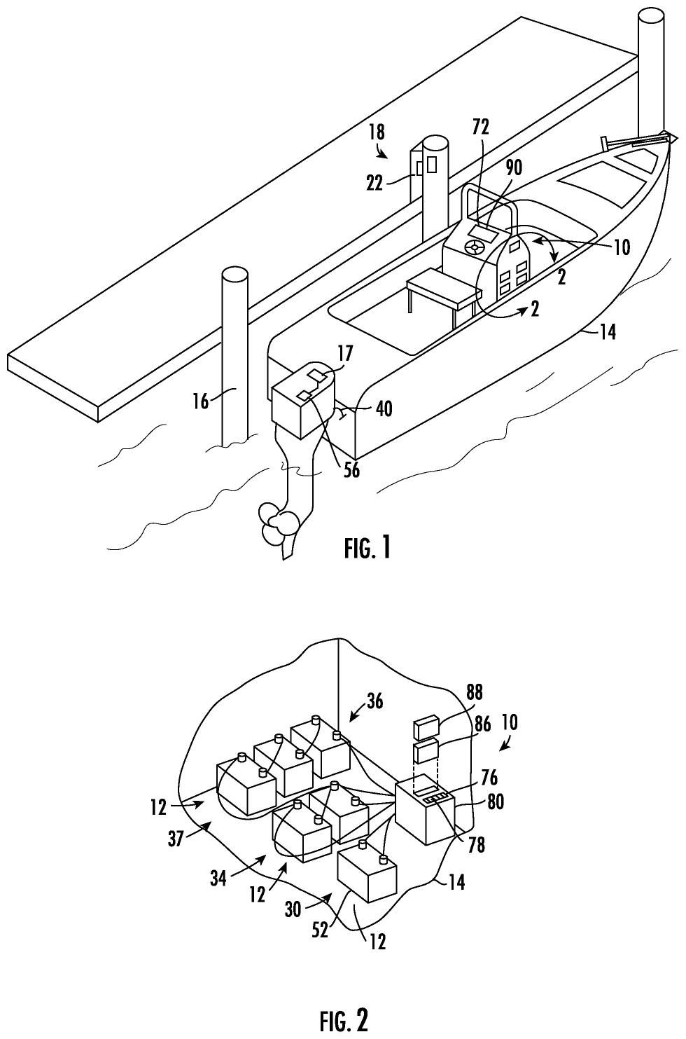

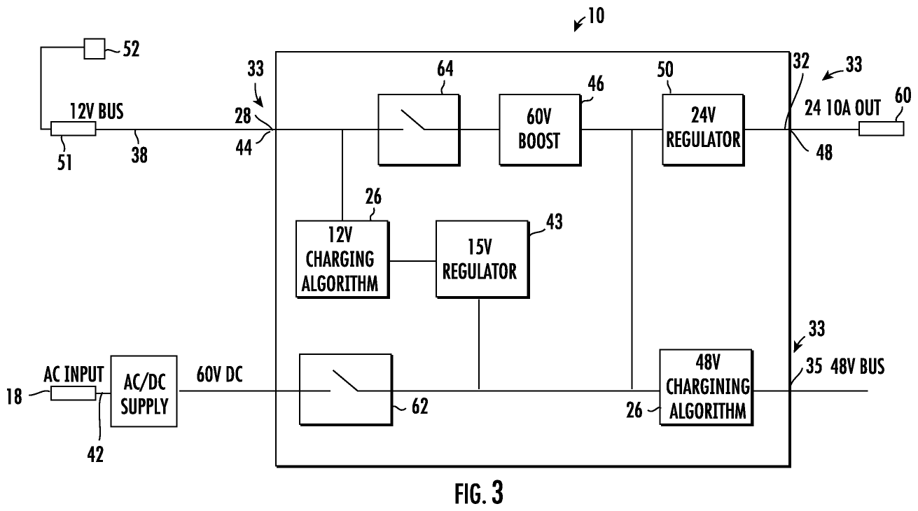

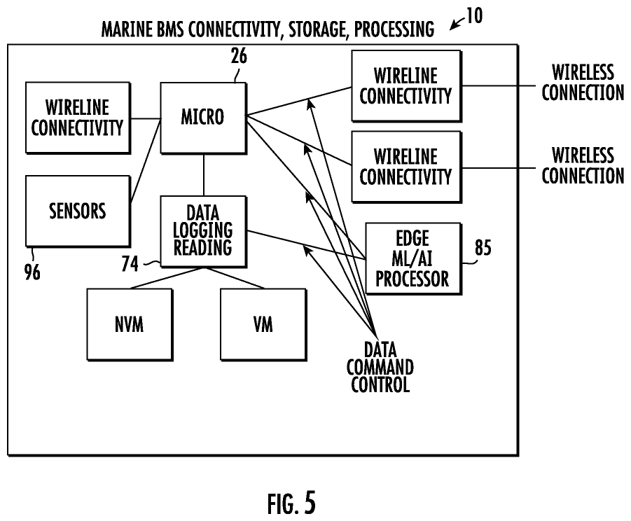

As shown in FIGS. 1-9, a battery management system 10 for at least two battery circuits 12 on a vessel 14 in which the battery circuits 12 may be charged by a motor 16 on the vessel 14 or by a power source 18 positioned remotely from the vessel 14 is disclosed. As such, the two battery circuits 12 may have different nominal voltages configured to provide different voltages to different devices 20 onboard the vessel 14. The battery management system 10 may receive input power from the one or more motors 16 on the vessel 14 to charge the at least two battery circuits 12 on the vessel 14. The battery management system 10 may be configured such that when the battery management system 10 is not receiving power from the motor 16 on the vessel 14, the battery management system 10 may receive power from a power source 18 positioned remotely from the vessel 14, such as, a municipal power supply 22. The battery management system 10 may also include a communication system 24 enabling battery management data to be shared with users.

In at least one embodiment, the battery management system 10 may be configured to provide a number of benefits to a battery system 36 of a vessel 14. In particular, the battery management system 10 may be configured to control charging of two or more battery circuits 12 having different voltages. In at least one embodiment, the battery management system 10 may charge a 12 volt battery circuit usable to provide 12 volt power to accessories on the vessel 14 and may charge another battery circuit having another voltage, such as, but not limited to, 24 volts, 36 volts or 48 volts. The battery management system 10 may be configured to run diagnostic analyses of the batteries in the battery circuits to identify a number of specifications, including, but not limited to, state of charge, battery temperature, amount of charge and the like. The battery management system 10 may be configured to communicate this information to one or more people via wired or wireless communications to systems on the vessel 14 or off of the vessel 14. The battery management system 10 may include one or more machine learning models to create one or more predictions regarding one or more batteries 36 in the battery circuits 12.

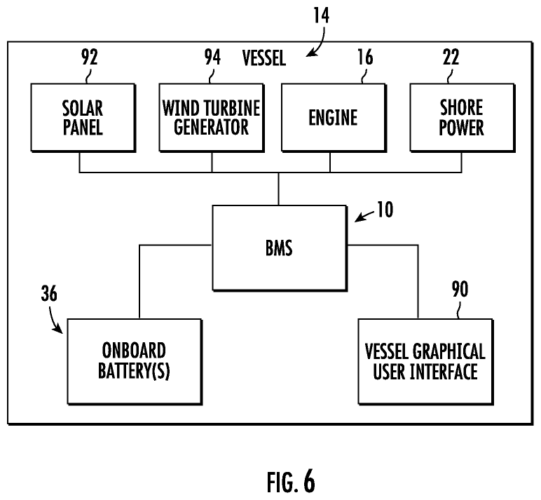

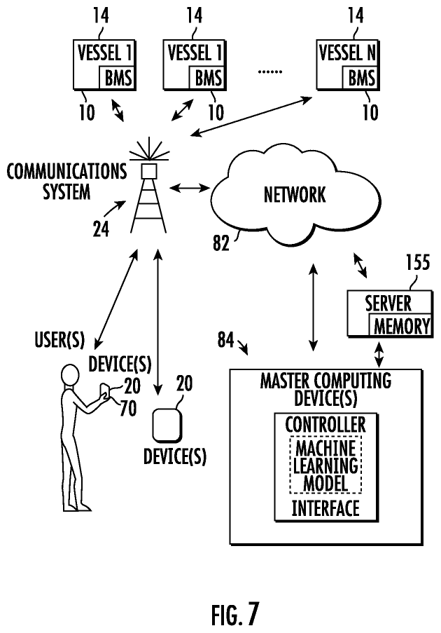

In at least one embodiment, the battery management system 10 may include a controller 26 configured to be coupled to multiple battery circuits 12. The controller 26 may include a first outlet 28 configured to be coupled to one or more first battery circuits 30 having a first nominal voltage and a second outlet 32 configured to be coupled to one or more second battery circuits 34 having a second nominal voltage that differs from the first nominal voltage of the first battery circuit 30. The battery management system 10 may include one or more first power inputs 38 configured to be coupled to an electrical output 40 from one or more motors 16 of a vessel 14. The battery management system 10 may include one or more second power inputs 42 configured to be coupled to a power source 18 other than the motor 16 of the vessel 14. The power source 18 may be, but is not limited to being, shore power 22, solar power 92 via one or more solar panels, a generator and a wind turbine generator 94, as shown in FIG. 6. The controller 26 may be configured to generate a first charging current according to a first charging profile for charging batteries 36 in the one or more first battery circuits 30 having a first nominal voltage and a second charging current according to a second charging profile for charging batteries 36 in the one or more second battery circuits 34 having a second nominal voltage. In at least one embodiment, the controller 26 may be configured to generate the first and second charging currents simultaneously. In other embodiments, the controller 26 may be configured to generate the first and second charging currents other than simultaneously.

As shown in FIG. 3, the battery management system 10 may include three or more outlets 33 configured to supply charging current to battery circuits 12 in addition to the first and second battery circuits 30, 34. In at least one embodiment, the battery management system 10 may include a third outlet 35 configured to be coupled to one or more third battery circuits 37 having a third nominal voltage that differs from the first nominal voltage of the first battery circuit 30. The nominal voltage of the third battery circuit 37 may be equal to or different than a nominal voltage of the second battery circuit 34. As such, the third battery circuit 37 may have a nominal voltage that differs from the first battery circuit 30 and is the same or different than a nominal voltage of the second battery circuit 34. The battery management system 10 is not limited to three battery circuits 12 but may have any desired number of battery circuits 12 which may all have different nominal battery voltages or which some may have different nominal voltages and some may be the same nominal battery voltages.

In at least one embodiment, the controller 26 can determine what type of battery 36 exists in the first battery circuits 30, such as, but not limited to, lead acid, gel, absorbent glass mat (AGM), lithium iron phosphate (LiFePO₄) and yet to be conceived battery types, and implement a charging profile associated with that type of battery. The controller 26 may automatically determine the battery type for each of the first and second battery circuits 34. The controller 26 may also receive input from a user setting the battery type. A user may input a battery type matching the batteries 36 of the system 10 into the battery management system 10 electronically via one or more of the numerous communication systems set forth herein or manually via one or more switches or one or more push buttons.

The battery management system 10 may include a first regulator 43 positioned in-line with a first output 44 such that the first regulator 43 receives a voltage higher than the first output 44 and converts the input voltage to a voltage lower than the input voltage. In at least one embodiment, the first regulator 43 is a 15 volt regulator that may be configured to receive voltage between 60 volts and 220 volts. In other embodiments, the first regulator 43 is not limited to being a 15 volt regulator but may be configured to be another voltage.

The battery management system 10 may include a first booster 46 upstream from one or more second outputs 48. The first boost 46 may receive power at a voltage lower than a desired nominal voltage corresponding to a desired nominal voltage for the second output 48. In at least one embodiment, the first boost 46 may receive 12 volt nominal input power and output power at 60 volts. The first boost 46 may receive 12 volt nominal input power from a 12 volt source, such as, but not limited to, one or more electrical systems 17 of one or more motors 16 of a vessel 14.

The battery management system 10 may include a second regulator 50 positioned in-line with a second output 48 such that the second regulator 50 receives a voltage higher than the second output 48 and converts the input voltage to a voltage lower than the input voltage. In at least one embodiment, the second regulator 50 is a 24 volt regulator that may be configured to receive power with a voltage between 60 volts and 220 volts. In other embodiments, the first regulator 43 is not limited to being a 24 volt regulator but may be configured to be another voltage. The second regulator 50 may receive input power from the first booster 46 or the second power input 42.

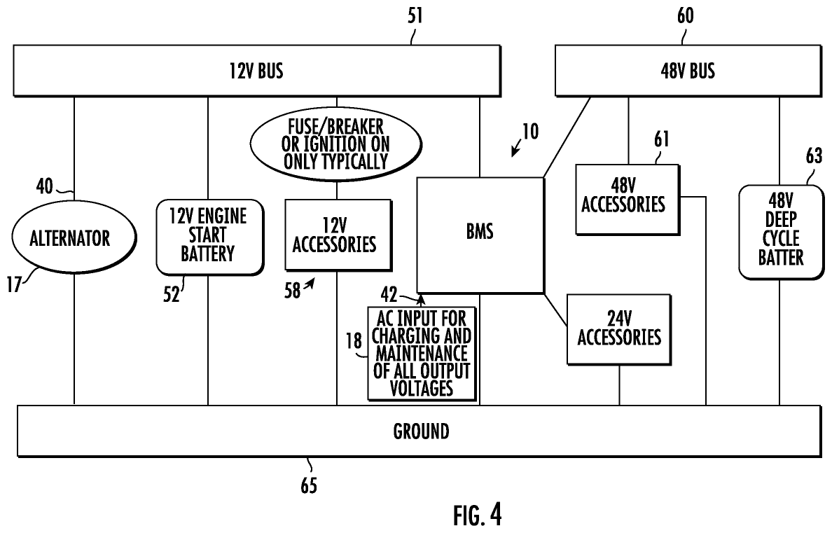

In at least one embodiment, as shown in FIGS. 3 and 4, the battery management system 10 may include a first bus 51 configured to be coupled to the first outlet 28 to receive the first charging current according to the first charging profile for charging one or more batteries 36 in the first battery circuit 30. As shown in FIGS. 3 and 4, the first bus 51 may be configured to enable one or more accessories 58 to be coupled to the first bus 51. The accessories 58 may include, but are not limited to, smartphones, spotlights and rechargeable portable speakers. The first bus 51 may also be in electrical communication with one or more engine starting batteries 52. In at least one embodiment, the first bus 51 may also be in electrical communication with one or more electrical systems 17 of the vessel's motor 16. In such configuration, the first bus 51 may also be in electrical communication with one or more alternators 56 in the electrical system 17 of the vessel's motor 16. The first bus 51 may be configured so that each of the engine starting batteries 52, electrical systems 17 of the vessel's motor 16, accessories 58 and other devices may be coupled to the first bus 51 simultaneously. In at least one embodiment, a first nominal voltage of the first battery circuit 30 coupled to the first bus 51 and first outlet 28 may be 12 volts. In other embodiments, the first nominal voltage of the first battery circuit 30 may be another voltage other than 12 volts, such as, but not limited to 6 volts, 18 volts, 24 volts and 48 volts.

As shown in FIGS. 3 and 4, the battery management system 10 may include a second bus 60 configured to be coupled to the second outlet 32 to receive a second charging current according to a second charging profile for charging one or more batteries 36 in the second battery circuit 34. The second nominal voltage of the second battery circuit 34 may be different than the first nominal voltage of the first battery circuit 30. In at least one embodiment, the second nominal voltage of the second battery circuit 34 may be greater than 12 volts. The second nominal voltage of the second battery circuit 34 may be, but it not limited to being, 24 volts, 36 volts, 48 volts. One or more accessories 61 may be coupled to the second bus 60. The accessories 61 may be any device needing power at the voltage available on the second bus 60. One or more batteries 63 may provide the power for the second battery circuit 34. As shown in FIG. 4, a common ground may be used for the battery management system 10.

In at least one embodiment, as shown in FIG. 3, the first outlet 28 and the first power input 38 may be coupled together such that when the controller 26 is receiving power from the electrical output from the motor 16 of the vessel 14, a common first bus 51 coupled to the first output 44 and the first power input 38 functions as power input to the controller 26. Also, when the controller 26 receives power from a power source 18 other than the motor 16 of the vessel 14, the first common bus 50 coupled to the first output 44 and the first power input 38 functions as power output from the controller 26 to devices coupled to the first bus 51. In such situation, the first switch 62 between the first regulator 43 and the power source 18 may be closed, and the second switch 64 between the first booster 46 and the first bus 51 may be opened so that power received from the power source 18 may be sent to the common first bus 51 coupled to the first output 44 and the other outlets 32, 35. In the scenario in which the battery management system 10 receives power from the motor 16 of the vessel 14, first switch 62 between the first regulator 43 and the power source 18 may be opened, and the second switch 64 between the first booster 46 and the first bus 51 may be closed to allow power to flow from the vessel electrical system 17 to the first booster 46 and prevent back feeding into the power source 18.

The battery management system 10 may also be configured to provide data regarding the one or more batteries 36 onboard the vessel 14. In at least one embodiment, the battery management system 10 may provide a communication system 24 configured to transmit data regarding the one or more batteries 36 onboard the vessel 14. The communication system 24 may transmit data from the controller 26 to one or more devices 20, which may be a remote device 20, viewable by a user. The device 20 may be, but is not limited to being, a mobile device, such as, but not limited to, a smartphone 70, a personal computer, a laptop, a tablet, phablet, any device configured to access the internet through a wired connection, wireless connection, or both, and a vessel information system 72 on a vessel 14. The communication system 24 may transmit data through a wired connection or wirelessly, or both, from the controller 26 to the remote device 20. The communication system 24 may include a transceiver and other components already conceived or yet to be conceived that are configured to send and receive wireless communications. The communication system 24 may be configured to send and receive wireless communication via communication systems, such as, but not limited to, satellite, cell towers configured for wireless broadband communication, WiFi, short-range wireless communications, such as, but not limited to, Bluetooth.

The communication system 24 may be configured to communicate with one or more devices 20 on the vessel 14. In particular, the communication system 24 may be configured to communicate with one or more vessel information systems 72 on the vessel 14, as shown in FIG. 1. The vessel information system 72 may be, but is not limited to being, one or more graphical user interfaces 90, as shown in FIGS. 1 and 6, such as those used as an operations system, navigation system, such as, but not limited to, a global positioning system (GPS), fuel management system and depth finder. The communication system 24 may be configured to communicate with one or more vessel information systems 72 on the vessel 14 via wired or wireless systems. As concerning a wired system, the battery management system 10 may be configured to be coupled via wire via any type of connection which may or may not be releasable via communications protocol, such as, but not limited to, NMEA 2000 protocols, other existing communication protocols or yet to be conceived communication protocols. As concerning a wireless system, the battery management system 10 may be configured to be coupled wirelessly via WiFi, Bluetooth or other wireless system.

The communication system 24 may be configured to communicate with one or more databases that are not housed in the vessel 14, but are housed remote relative to the vessel 14, such as, but not limited to, a server, the cloud, and the like. The remote databases may be accessed by any device capable of providing access to the internet. The communications system 24 may communicate with an internet site that enables users to create secure, limited access accounts enabling one or more users to view data associated with a batter management system 10 associated that user's account. A user's account may include one or a plurality of battery management systems 10 associated with a plurality of vessels 14. The communications system 24 may include a mobile application, referred to as an App, providing a user access to the one or more databases storing information similarly to the internet site that provides access. The App may be available on devices, such as, but not limited to, mobile devices such as smartphones, tablets and the like.

The battery management system 10 may be configured to send data to a user to alert the user as set forth herein. The data may include, but is not limited to, state of charge for each battery, nominal charge for each battery, state of charge of at least the first and second battery circuits 30, 34, nominal charge for each battery circuit 30, 34, state of charging (charging/not charging) of the circuits 30, 34, the type of battery chemistry for each battery, such as, but not limited to, lead acid, gel and absorbed glass mat (AGM), rate of charge for each battery, electrical current flow into each input 38, 42 and others and out of each output 28, 32 and others, ambient temperature, temperature of each battery, estimates of when the state of charge of each battery will be at 75%, 50%, 25% based on current loads on the batteries, and time and date stamps of most recent updates. The data may be stored locally in memory 74 within the battery management system 10 onboard the vessel 14 and may be uploaded to one or more remote databases when the battery management system 10 is able to connect to the internet.

The battery management system 10 may be configured to provide notification of various data, such as, but not limited to, operating conditions. The batter management system 10 may transmit such data via a notification system 76. In at least one embodiment, the battery management system 10, such as via the controller 26, may be configured to provide notification of whether input power is received by the controller 26 from the motor 16 of the vessel or whether input power is received from another source, such as but limited to, municipal power, which is often referred to as shore power. The notification system 76 may be configured to provide notification of data regarding the at least one first battery circuit 30 having the first nominal voltage or data regarding the at least one second battery circuit 34 having the second nominal voltage, or both. The notification system 76 may be configured to provide notification of an out of specification condition of the first battery circuit 30 having the first nominal voltage, such as when the voltage of the first battery circuit 30 drops below a threshold level. Similarly, the notification system 76 may be configured to provide notification of an out of specification condition of the second battery circuit 32 having the first nominal voltage, such as when the voltage of the second battery circuit 32 drops below a threshold level. The notification system 76 may also provide notice of whether the first and second inputs 38, 42 and the first and second outlets 28, 32 are correctly connected and whether one or more batteries is out of specification in one or more of the ways set forth herein and notice of any other error or out or specification condition. In at least one embodiment, the notification system 76 provides notification of data via one or more visual indicators 78. The visual indicators 78 may be positioned on a housing 80 containing components of the battery management system 10, such as, but not limited to, the controller 26. The visual indicators 78 may be, but are not limited to being, lights, such as one or more light emitting diodes (LED) and the like.

The battery management system 10 may provide data, such as, but not limited to diagnostic, predictions or status, or any combination thereof to one or more users or others. Data may be shared between the battery management system 10 and a network 82 controlled by one or more people or entities supporting the battery management system 10 on a real-time basis via wireless communications—cell transmission within BMS, via cell phone, via satellite communications or other methods of communication already conceived or yet to be conceived. The battery management system 10 may provide real-time data to an account set up on the network 82 which is accessible by the one who set up the account and anyone else who has been granted access, such as, but not limited to, one or more owners of a vessel 14, one or more captains of the vessel 14, one or more vessel management companies or anyone else granted access to the account, or any combination thereof. The data may include, but is not limited to, notification, such as via app, text message, email and other manners of communication, notification of the state of charge of each battery or notification to hookup the battery management system 10 to shore power if the user forgot to hookup the vessel 14 to shore power when the vessel 14 was last used, or both. The battery management system 10 may learn that a vessel 14 is returned to its home dock or storage location via a global positioning system (GPS) with geofencing. The data may include, but is not limited to, notification of overcharge or other unsafe conditions with recommendations to disable a problem battery, high/low temperatures, under voltage, over voltage, unable to detect batteries, bulk timer errors, reverse polarity errors, battery temp, battery health or state of charge or any combination thereof. The data may include whether one or more batteries 36 is operating within acceptable parameters (temp, voltage, amperage et cetera) during different portions of a charging cycle. The data may include one or more alerts via the vessel navigation system, app, text, email and the like if a battery 36 is outside of the identified parameters. The data may include identification of a failure of a battery 36 onboard the vessel 14. The data may include notification of combustible fumes around the housing 80 of the battery management system 10 onboard the vessel 14.

The battery management system 10 may provide information directly to a calendar associated with an account on the network 82. In at least one embodiment, the calendar may be associated with one or more vessel owners, one or more captains of the vessel 14, one or more vessel management companies and the like. In at least one embodiment, the battery management system 10 may provide information to a calendar system, such as, but not limited to MICROSOFT OUTLOOK to identify one or more owners' boat trip plans and advise the boat owner to connect shore power to the battery management system 10 ahead of the trip.

The battery management system 10 may include a machine learning model 84, 85 configured to generate predictions relative to the system 10. In general, an artificial intelligence system may include a machine-learning model. The machine-learning model may be trained using a supervised method where the parameters in the machine-learning model are adjusted to minimize or reduce the error between known outputs resulted from respective inputs and computed outputs generated from applying the inputs to the machine-learning model. Examples of supervised learning/training methods include reinforcement learning, and learning with error correction.

Alternatively, or in combination, a machine-learning model may be trained using an unsupervised method where the exact outputs resulting from a given set of inputs are not known before the completion of training. The machine-learning model can be trained to classify an item into a plurality of categories, or data points into clusters. Multiple training algorithms can be employed for a sophisticated machine learning/training paradigm.

In one example, an artificial intelligence system may be configured as an machine learning model 84, 85 that is trained using reinforcement learning. For example, the artificial intelligence system may gather images, voice recordings, and other sensor data for one or more sensors 96 in connection with the battery management system 10 and store the data in a database. Each time the vessel 14 is used, an account associated with the vessel 14 is identified in the network 82, and the data for that vessel 14 in connection to that account is reinforced in the machine-learning model. Over time the machine-learning model captures sensor data under different conditions (e.g., different vessel operation, different power requirements from the battery management system 10, different environmental conditions, such as, but not limited to, temperature, humidity et cetera) and will learn and reinforce data associated with the vessel 14. The machine learning model 84 may be a part of the cloud, and the machine learning model 85 may be positioned within a vessel 14.

In at least one embodiment, the battery management system 10 may include a machine learning model 84, 85 configured to generate predictions relative to the at least one first battery circuit 30 having the first nominal voltage. The machine learning model 84, 85 may be configured to generate predictions relative to the second battery circuit 34 having a second nominal voltage. The machine learning model 84, 85 may be configured to receive data from the controller 26, process the data and generate at least one prediction relative to the first battery circuit 30 having the first nominal voltage.

The machine learning model 84, 85 may gather data from one or multiple battery management systems 10, which may be positioned on one or multiple vessels 14. The machine learning model 84, 85 may make numerous predictions, including but not limited to, the following. The machine learning model 84, 85 may predict life of a battery 36 based on date put in service, usage, temperature humidity, storage environment et cetera. The machine learning model 84, 85 may predict when each battery 36, such as, but not limited to a vessel house battery or a vessel starting battery, or both, will drop below a usable state of charge. The machine learning model 84, 85 may receive data from the controller 26 or other sensors 96 onboard one vessel 14 or a plurality of vessels 14, such as, but not limited to, all vessels having accounts in the network 82. The machine learning model 84, 85 may receive data such as, but not limited to, battery capacity, nominal voltage, chemistry, number of charge cycles, time it takes to charge and environmental conditions. The machine learning model 84, 85 may generate predictions of battery life and other predictions based on data from some or all vessels 14 connected to the network 82. The battery management system 10 may use of the prediction of battery life generated by the machine learning model 84, 85 to generate a recommendation of when to replace the battery or a recommendation to check the battery, or both. The machine learning model 84, 85 may generate predictions such as a time of day, i.e. 12:35 PM, to start the motor 16 to begin recharging the batteries 36 so the vessel 14 doesn't become stranded. The machine learning model 84, 85 may generate a prediction of when a state of charge of a battery 36 would get below 75%, 50%, 25% based on current power draw in the vessel electrical system on the batteries. In such situation, a vessel user would decide when to start the motor 16 to charge the batteries 36.

The machine learning model 84, 85 may generate a prediction of a date, i.e. Jan. 25, 2023, when each battery will need to be tested/checked/load-tested. The machine learning model 84, 85 may generate a prediction of an amount of time, such as hours and minutes, until each battery 36 reaches full charge based on the operating RPM of the motor 16 and current accessory use, such as sound system, phone recharging, spotlight use, et cetera. One or more sensors 96 may determine current flow measurements from the first and second battery circuits 30, 34 and current from the motor 16. The machine learning model 84, 85 may receive current-in data, current-out to batteries/BUS data and batteries/BUS voltages to determine a state of charge of one or more batteries or first and second battery circuits 30, 34. If current-in is great than current out and battery/BUS voltage are not dropping, then the battery charge is not decreasing and a battery 36 or battery circuits 30, 34 will not run out of charge. If current-in is less than or equal to current out and battery/BUS voltage is dropping, the battery 36 or battery circuit 30, 34 will run out of charge. In at least one embodiment, the battery management system 10 may include a tensor processing unit or other local artificial intelligence/machine learning processor. As such, the battery management system 10 may perform edge computing and predictive analysis without needing cloud/internet connection, which occurs often in remote geographic locations that vessels 14 are often in.

The battery management system 10 may be configured such that the battery management system 10 is adaptable to different electrical demands. For example, a larger vessel 14 may have battery circuits with larger number of batteries or larger capacities such as measured via amp hours, necessitating larger charging currents. Thus, in at least one embodiment, the battery management system 10 may be configured for small vessels with an anticipated input current from shore power of less than 15 Amps and another system configured larger vessels with an anticipated input current from shore power of less than 60 Amps. In at least one embodiment, the battery management system 10 may include a first alternating current input module 86 configured to be removably positioned inline between the controller 26 and a power source 18 other than the at least one motor 16 of the vessel 14 and a second alternating current input module 88 configured to be removably positioned inline between the controller 26 and a power source 18 other than the at least one motor 16 of the vessel 14, wherein the second alternating current input module 88 has a different maximum amperage than the first alternating current input module 86. The battery management system 10 is not limited to only two different current input modules 86, 88 but may have any number of current input modules configured with differing maximum input power limits. In at least one embodiment, the first and second alternating current input modules 86, 88 may be configured to each be removable devices configured to be removably attached inline between a power source 18 and one or more controllers 26 or other components of the battery management system 10. The current input modules 86, 88 may be attachable such as via a releasable plug attachment, NEMA certified cable or other appropriate manner.

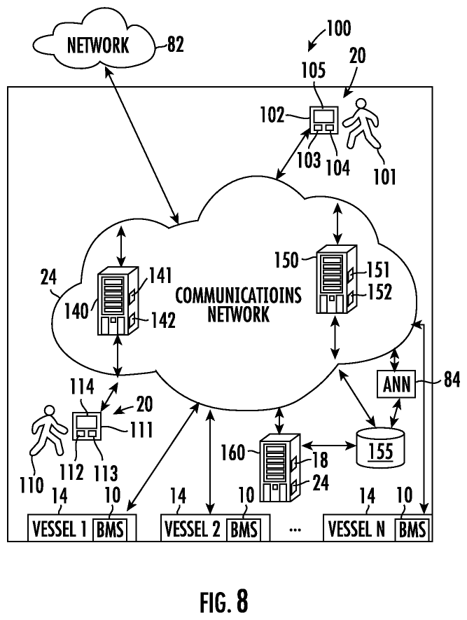

In at least one embodiment, the wireless communication system 100, as shown in FIG. 8, may include a first user device 102 utilized by the first user 101 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102, to interact with various applications executing within the system 10, and to interact with the system 10 itself. In certain embodiments, the first user device 102 may include components that provide non-visual outputs. For example, the first user device 102 may include speakers, haptic components, tactile components, or other components, which may be utilized to generate non-visual outputs that may be perceived and/or experienced by the first user 101. In certain embodiments, the first user device 102 may be configured to not include interface 105. In certain embodiments, the first user device 102 may be a computer, a laptop, a tablet device, a phablet, a server, a mobile device, a smartphone, a smart watch, and/or any other type of computing device. Illustratively, the first user device 102 is shown as a mobile device in FIG. 8.

In addition to the first user 101, the system 10 may include a second user 110, who may utilize a second user device 111 to access data, content, and applications, or to perform a variety of other tasks and functions. As with the first user 101, in certain embodiments, the second user 110 may be any type of user that may review data from the system 10. Much like the first user 101, the second user 110 may utilize second user device 111 to access an application (e.g. a browser or a mobile application) executing on the second user device 111 that may be utilized to access web pages, data, and content associated with the system 10. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. a screen, a monitor, a graphical user interface, etc.) that may enable the second user 110 to interact with various applications executing on the second user device 111, to interact with various applications executing in the system 10, and to interact with the system 10. In certain embodiments, the second user device 111 may be a computer, a laptop, a tablet device, a phablet, a server, a mobile device, a smartphone, a smart watch, and/or any other type of computing device. Illustratively, the second user device 111 may be a computing device in FIG. 8. The second user device 111 may also include any of the componentry described for first user device 102.

In certain embodiments, the first user device 102 and the second user device 111 may have any number of software applications and/or application services stored and/or accessible thereon. In certain embodiments, the software applications and services may include one or more graphical user interfaces so as to enable the first and second users 101, 110 to readily interact with the software applications of the system 10. The software applications and services may also be utilized by the first and second users 101, 110 to interact with any device in the system 10, any network in the system 10, or any combination thereof.

The system 10 may also include a communications network 24. The communications network 24 of the system 10 may be configured to link each of the devices in the system 10 to accounts storing the batter management system data. For example, the communications network 24 may be utilized by the first user device 102 to connect with other devices within or outside communications network 24. Additionally, the communications network 24 may be configured to transmit, generate, and receive any information and data traversing the system 10. In certain embodiments, the communications network 24 may include any number of servers, databases, or other componentry, and may be controlled by a service provider. The communications network 24 may also include and be connected to a cloud-computing network, a phone network, a wireless network, an Ethernet network, a satellite network, a broadband network, a cellular network, a private network, a cable network, the Internet, an internet protocol network, a content distribution network, a virtual private network, any network, or any combination thereof. Illustratively, server 140 and server 150 are shown as being included within communications network 24.

Notably, the functionality of the battery management system 10 may be supported and executed by using any combination of the servers 140, 150, and 160. The servers 140, and 150 may reside in communications network 24, however, in certain embodiments, the servers 140, 150 may reside outside communications network 24. The servers 140 and 150 may be utilized to perform the various operations and functions provided by the system 10, such as those requested by applications executing on the first and second user devices 102, 111. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 150 may include a memory 151 that includes instructions, and a processor 152 that executes the instructions from the memory 151 to perform the various operations that are performed by the server 150. In certain embodiments, the servers 140, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 150 may be communicatively linked to the communications network 24, any network, any device in the system 10, or any combination thereof.

The database 155 of the battery management system 10 may be utilized to store and relay information that traverses the battery management system 10, cache information and/or content that traverses the battery management system 10, store data about each of the devices in the system 10, and perform any other typical functions of a database. In certain embodiments, the database 155 may store the output from any operation performed by the system 10, operations performed and output generated by the battery management system 10 on each vessel 14, results from the machine learning model 84, 85, first and second user devices 102, 111, the servers 140, 150, 160, or any combination thereof. In certain embodiments, the database 155 may store a record of any and all information obtained from any data sources utilized by the battery management system 10 to facilitate the operative functions of the system 10 and its components, store feedback received from the first and second users 101, 110 and/or the first and second user devices 102, 111, store any information generated and/or received by the battery management system 10 or any other data traversing the battery management system 10, or any combination thereof. In certain embodiments, the database 155 may be connected to or reside within the communications network 24, any other network, or a combination thereof. In certain embodiments, the database 155 may serve as a central repository for any information associated with any of the devices and information associated with the battery management system 10. Furthermore, the database 155 may include a processor and memory or be connected to a processor and memory to perform the various operations associated with the database 155. In certain embodiments, the database 155 may be connected to the servers 140, 150, 160, the first user device 102, the second user device 111, any devices in the system 10, any other device, any network, or any combination thereof.

The database 155 may also store information obtained from the battery management system 10, store information associated with the first and second users 101, 110, store location information for the first and second user devices 102, 111 and/or first and second users 101, 110, store user profiles associated with the first and second users 101, 110 and the battery management systems 10 on each vessel 14, store device profiles associated with any device in the system 10, store communications traversing the battery management system 10, store user preferences, store information associated with any device or signal in the battery management system 10, store information relating to usage of applications accessed by the first and second user devices 102, 111, store any information obtained from any of the networks in the system 10, store historical data associated with the first and second users 101, 110 and the battery management systems 10 on each vessel 14, store device characteristics, store information relating to any devices associated with the first and second users 101, 110 and the battery management systems 10 on each vessel 14, or any combination thereof. The user profiles may include any type of information associated with an individual (e.g. first user 101 and/or second user 110), such as, but not limited to a username, a password, contact information, demographic information, psychographic information, an identification of applications used or associated with the individual, any attributes of the individual, any other information, vessel information, home port, vessel length, vessel color, electrical components on the vessel; engines on the vessel, size of alternator on each engine, electrical output from the engines at all ranges of operation or a combination thereof. Device profiles may include any type of information associated with a device, such as, but not limited to, operating system information, hardware specifications, information about each component of the device (e.g. sensors 96, processors, memories, batteries, etc.), attributes of the device, any other information, or a combination thereof.

In certain embodiments, the database 155 may store algorithms facilitating the operation of the system 10 itself, any software application utilized by the system 10, or any combination thereof. In certain embodiments, the database 155 may be configured to store any information generated and/or processed by the system 10, store any of the information disclosed for any of the operations and functions disclosed for the system 10 herewith, store any information traversing the system 10, or any combination thereof. Furthermore, the database 155 may be configured to process queries sent to it by any device in the system 10.

In certain embodiments, the system 10 may communicate and/or interact with an external network 82. In certain embodiments, the external network 82 may include any number of servers, databases, or other componentry, and, in certain embodiments, may be controlled by a service provider. The external network 82 may also include and be connected to a cloud-computing network, a phone network, a wireless network, an Ethernet network, a satellite network, a broadband network, a cellular network, a private network, a cable network, the Internet, an internet protocol network, a content distribution network, a virtual private network, any network, or any combination thereof.

The system 10 may also include a software application or program, which may be configured to perform and support the operative functions of the system 10. In certain embodiments, the application may be a software program, a website, a mobile application, a software application, a software process, or a combination thereof, which may be made accessible to users utilizing one or more computing devices, such as first user device 102 and second user device 111. The application of the system 10 may be accessible via an internet connection established with a browser program executing on the first or second user devices 102, 111, a mobile application executing on the first or second user devices 102, 111, or through other suitable means. Additionally, the application may allow users and computing devices to create accounts with the application and sign-in to the created accounts with authenticating username and password log-in combinations. In certain embodiments, the software application may execute directly as an installed program on the first and/or second user devices 102, 111, such as a mobile application or a desktop application. In certain embodiments, the software application may execute directly on any combination of the servers 140, 150, 160.

The software application may include multiple programs and/or functions that execute within the software application and/or are accessible by the software application. For example, the software application may include an application that generates web content and pages that may be accessible to the first and/or second user devices 102, 111, any type of program, or any combination thereof.

Notably, in certain embodiments, various functions and features of the system 10 may operate without human intervention and may be conducted entirely by computing devices, robots, programs, and/or processes. For example, in certain embodiments, multiple computing devices may interact with devices of the system 10 to provide the functionality supported by the system 10.

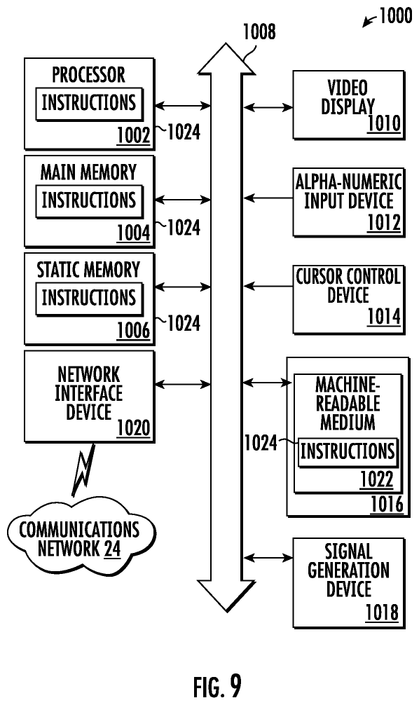

Referring now also to FIG. 9, at least a portion of the methodologies and techniques described with respect to the exemplary embodiments of the system 10 can incorporate a machine, such as, but not limited to, computer system 1000, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10.

In some embodiments, the machine may operate as a standalone device. In some embodiments, the machine may be connected (e.g., using communications network 24, another network, or a combination thereof) to and assist with operations performed by other machines and systems, such as, but not limited to, the first user device 102, the second user device 111, the server 140, the server 150, the database 155, the server 160, or any combination thereof. The machine may assist with operations performed by other component in the system, any programs in the system, or any combination thereof. The machine may be connected with any component in the system 10. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1000 may include a processor 1002 (e.g., a central processing unit (CPU), a graphics processing unit (GPU, or both), a main memory 1004 and a static memory 1006, which communicate with each other via a bus 1008. The computer system 100 may further include a video display unit 1010, which may be, but is not limited to, a liquid crystal display (LCD), a flat panel, a solid state display, or a cathode ray tube (CRT). The computer system 100 may include an input device 1012, such as, but not limited to, a keyboard, a cursor control device 1014, such as, but not limited to, a mouse, a disk drive unit 1016, a signal generation device 1018, such as, but not limited to, a speaker or remote control, and a network interface device 1020.

The disk drive unit 1016 may include a machine-readable medium 1022 on which is stored one or more sets of instructions 1024, such as, but not limited to, software embodying any one or more of the methodologies or functions described herein, including those methods illustrated above. The instructions 1024 may also reside, completely or at least partially, within the main memory 1004, the static memory 1006, or within the processor 1002, or a combination thereof, during execution thereof by the computer system 100. The main memory 1004 and the processor 1002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations may include, but are not limited to, distributed processing or component/object distributed processing, parallel processing, or virtual machine processing can also be constructed to implement the methods described herein.

The present disclosure contemplates a machine-readable medium 1022 containing instructions 1024 so that a device connected to the communications network 24, another network, or a combination thereof, can send or receive voice, video or data, and communicate over the communications network 24, another network, or a combination thereof, using the instructions. The instructions 1024 may further be transmitted or received over the communications network 24, another network, or a combination thereof, via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

During use, the battery management system 10 enables multiple battery circuits 30, 34, 37 having different nominal voltages to be charged via power generated by the one or more motors 16 of a vessel 14 or from another source, such as but not limited to shore power 22, a generator, a solar panel 92, a wind turbine generator and the like. As such, the multiple battery circuits 30, 34, 37 can be charged at dock and when the vessel is underway, thereby enabling the multiple battery circuits 30, 34, 37 to retain battery charge while under load when the vessel is being used. Conveniently, the battery management system 10 keeps the captain informed regarding all aspects of the multiple battery circuits 30, 34, 37 via the vessel information system 72, an app on the captain's phone or visual indicators, or any combination thereof. The captain can easily determine the state of charge of the multiple battery circuits 30, 34, 37 and a number of other diagnostic data supplied by the battery management system 10. The battery management system 10 also provides predictions on when the multiple battery circuits 30, 34, 37 will reach various states of charge when under a particular load to enable a captain to prevent the vessel from becoming stranded because of dead batteries. The battery management system 10 also provides notifications and alerts to the captain to prevent undesirable outcomes, such as fire, a vessel becoming stranded and the like.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A battery management system for a vessel, comprising:
a controller configured to be coupled to multiple battery circuits and comprising a first outlet configured to be coupled to at least one first battery circuit having a first nominal voltage and a second outlet configured to be coupled to at least one second battery circuit having a second nominal voltage that differs from the first nominal voltage of the at one first battery circuit;
at least one first power input configured to be coupled to an electrical output from at least one motor of the vessel;
at least one second power input configured to be coupled to a power source other than the at least one motor of the vessel; and
wherein the controller is configured to generate a first charging current according to a first charging profile for charging batteries in the least one first battery circuit having the first nominal voltage and a second charging current according to a second charging profile for charging batteries in the least one second battery circuit having the second nominal voltage.

2. The battery management system of claim 1, further comprising a third outlet configured to be coupled to at least one third battery circuit having a third nominal voltage that differs from at least the first nominal voltage of the at least one first battery circuit.

3. The battery management system of claim 1, further comprising a first bus configured to be coupled to the first outlet to receive the first charging current according to the first charging profile for charging at least one battery in the at least one first battery circuit.

4. The battery management system of claim 3, wherein the first nominal voltage of the at least one first battery circuit is 12 volts.

5. The battery management system of claim 3, further comprising a second bus configured to be coupled to a second outlet to receive the second charging current according to the second charging profile for charging at least one battery in the at least one second battery circuit.

6. The battery management system of claim 5, wherein the second nominal voltage of the at least one second battery circuit is greater than 12 volts.

7. The battery management system of claim 5, wherein the first outlet and the at least one first power input are coupled together such that when the controller is receiving power from the electrical output from the at least one motor of the vessel, a common bus coupled to the first output and the at least one first power input functions as power input to the controller and when the controller is receiving power from a source other than the at least one motor of the vessel, the common bus coupled to the first output and the at least one first power input functions as power output from the controller.

8. The battery management system of claim 1, further comprising a communications system for transmitting data from the controller to at least one remote device viewable by a user.

9. The battery management system of claim 8, wherein the at least one remote device is a vessel information system on the vessel.

10. The battery management system of claim 8, wherein the at least one remote device is a wireless device.

11. The battery management system of claim 8, wherein the communications system transmits data wirelessly from the controller to the at least one remote device.

12. The battery management system of claim 1, wherein the controller is configured to provide notification of whether input power is received by the controller from the at least one motor of the vessel or another source.

13. The battery management system of claim 1, further comprising a notification system configured to provide notification of data regarding the at least one first battery circuit having the first nominal voltage and data regarding the at least one second battery circuit having the second nominal voltage.

14. The battery management system of claim 1, wherein the notification system is configured to provide notification of an out of specification condition of the at least one first battery circuit having the first nominal voltage.

15. The battery management system of claim 1, further comprising a first alternating current input module configured to be removably positioned inline between the controller and a power source other than the at least one motor of the vessel and a second alternating current input module configured to be removably positioned inline between the controller and a power source other than the at least one motor of the vessel, wherein the second alternating current input module has a different maximum amperage than the first alternating current input module.

16. The battery management system of claim 1, further comprising a machine learning model configured to generate predictions relative to the at least one first battery circuit having the first nominal voltage.

17. The battery management system of claim 16, wherein the machine learning model is configured to generate predictions relative to the at least one second battery circuit having a second nominal voltage.

18. The battery management system of claim 16, further comprising a machine learning model configured to receive data from the controller, process the data and generate at least one prediction relative to the at least one first battery circuit having the first nominal voltage.

19. A battery management system for a vessel, comprising:
a controller configured to be coupled to multiple battery circuits and comprising a first outlet configured to be coupled to at least one first battery circuit having a first nominal voltage and a second outlet configured to be coupled to at least one second battery circuit having a second nominal voltage that differs from the first nominal voltage of the at one first battery circuit;
at least one first power input configured to be coupled to an electrical output from at least one motor of the vessel;
at least one second power input configured to be coupled to a power source other than the at least one motor of the vessel;
wherein the controller is configured to generate a first charging current according to a first charging profile for charging batteries in the least one first battery circuit having the first nominal voltage and a second charging current according to a second charging profile for charging batteries in the least one second battery circuit having the second nominal voltage; and
wherein the controller is configured to generate the first and second charging currents simultaneously.

20. A battery management system for a vessel, comprising:
a controller configured to be coupled to multiple battery circuits and comprising a first outlet configured to be coupled to at least one first battery circuit having a first nominal voltage and a second outlet configured to be coupled to at least one second battery circuit having a second nominal voltage that differs from the first nominal voltage of the at one first battery circuit;
at least one first power input configured to be coupled to an electrical output from at least one motor of the vessel;
at least one second power input configured to be coupled to a power source other than the at least one motor of the vessel;
wherein the controller is configured to generate a first charging current according to a first charging profile for charging batteries in the least one first battery circuit having the first nominal voltage and a second charging current according to a second charging profile for charging batteries in the least one second battery circuit having the second nominal voltage; and
wherein the first outlet and the at least one first power input are coupled together such that when the controller is receiving power from the electrical output from the at least one motor of the vessel, a common bus coupled to the first output and the at least one first power input functions as power input to the controller and when the controller is receiving power from a source other than the at least one motor of the vessel, the common bus coupled to the first output and the at least one first power input functions as power output from the controller.
